(19) United States
(12) Patent Application Publication
(10) Pub. No.: US 2016/0249320 A1
(43) Pub. Date: Aug. 25, 2016

(54) MOBILE TERMINATED PERFORMANCE IN MULTI SUBSCRIBER IDENTITY MODULE MULTI STANDBY MOBILE COMMUNICATION DEVICES

(71) Applicant: QUALCOMM Incorporated, San Diego, CA (US)

(72) Inventors: Suresh Sanka, Hyderabad (IN); Parthasarathy Krishnamoorthy, Hyderabad (IN); Anand Rajurkar, Hyderabad (IN)

(21) Appl. No.: 14/626,855

(22) Filed: Feb. 19, 2015

(51) Int. Cl. H04W 68/02

(52) U.S. Cl. CPC H04W 68/02

(57) ABSTRACT

A method includes: detecting that a short data packet transmission will be performed on a first subscription over a first time period; determining whether a page reception will be performed on a second subscription during a second time period that includes at least a portion of the first time period; and in response to a determination that the page reception will be performed on the second subscription during the second time period, deferring the short data packet transmission on the first subscription until after the page reception on the second subscription is performed.

### BACKGROUND

To alert a mobile communication device to an incoming mobile terminated call (MTC), one or more base transceiver stations (BTSs) in a communication network may broadcast paging messages on the paging channel (PCH). As such, a mobile communication device may routinely monitor the PCH for paging messages.

In a multi-subscriber identity module (SIM) multi-standby (MSMS) mobile communication device, a single radio frequency (RF) chain may be shared between multiple subscriptions. However, a conventional MSMS mobile communication device may not tune-away from activities (e.g., short data packet transmission) on one subscription in order to permit another subscription to utilize the RF chain to receive paging messages. Thus, at least one subscription in a conventional MSMS mobile communication device may be unable to monitor the PCH on a consistent basis and may miss paging messages as a result.

Missed paging messages may cause the corresponding MTC to fail. Consequently, a user may miss voice calls despite having sufficient coverage from the communication network. Moreover, when a mobile communication device misses and fails to respond to a paging message, the communication network may repeatedly broadcast the same paging message. Thus, missed paging messages may also cause an increase in the signaling load of the communication network.

### SUMMARY

Apparatuses and methods for improving mobile terminated performance in MSMS mobile communication devices are provided.

According to the various embodiments, there is provided a method. The method may include: detecting that a short data packet transmission will be performed on a first subscription over a first time period; determining whether a page reception will be performed on a second subscription during a second time period that includes at least a portion of the first time period; and in response to determining that the page reception will be performed on the second subscription during the second time period, deferring the short data packet transmission on the first subscription until after the page reception on the second subscription is performed.

According to the various embodiments, there is provided a mobile communication device. In some embodiments, the mobile communication device may include a control unit and an RF chain.

The control unit may be configured to: detect that a short data packet transmission will be performed on a first subscription over a first time period; determine whether a page reception will be performed on a second subscription during a second time period that includes at least a portion of the first time period; and in response to determining that the page reception will be performed on the second subscription during the second time period, defer the short data packet transmission on the first subscription until after the page reception on the second subscription is performed.

According to various embodiments, there is provided a mobile communication device. In some embodiments, the mobile communication device may include: means for detecting that a short data packet transmission will be performed on a first subscription over a first time period; means for determining whether a page reception will be performed on a second subscription during a second time period that includes at least a portion of the first time period; and in response to a determination that the page reception is scheduled to be performed on the second subscription during the second time period, means for deferring the short data packet transmission on the first subscription until after the page reception on the second subscription is performed.

Other features and advantages of the present inventive concept should be apparent from the following description which illustrates by way of example aspects of the present inventive concept.

### BRIEF DESCRIPTION OF THE DRAWINGS

Aspects and features of the present inventive concept will be more apparent by describing example embodiments with reference to the accompanying drawings, in which:

FIG. 1 is a system diagram illustrating a network environment for various embodiments;

FIG. 2 is a block diagram illustrating a mobile communication device according to various embodiments;

FIG. 3A is a timeline illustrating a sequence of activities performed on multiple subscriptions according to various embodiments;

FIG. 3B is a timeline illustrating a sequence of activities performed on multiple subscriptions according to various embodiments; and

FIG. 4 is a flowchart illustrating a process for scheduling activities performed on multiple subscriptions according to various embodiments.

### DETAILED DESCRIPTION

While a number of embodiments are described herein, these embodiments are presented by way of example only, and are not intended to limit the scope of protection. The apparatuses and methods described herein may be embodied in a variety of other forms. Furthermore, various omissions, substitutions, and changes in the form of the example apparatuses and methods described herein may be made without departing from the scope of protection.

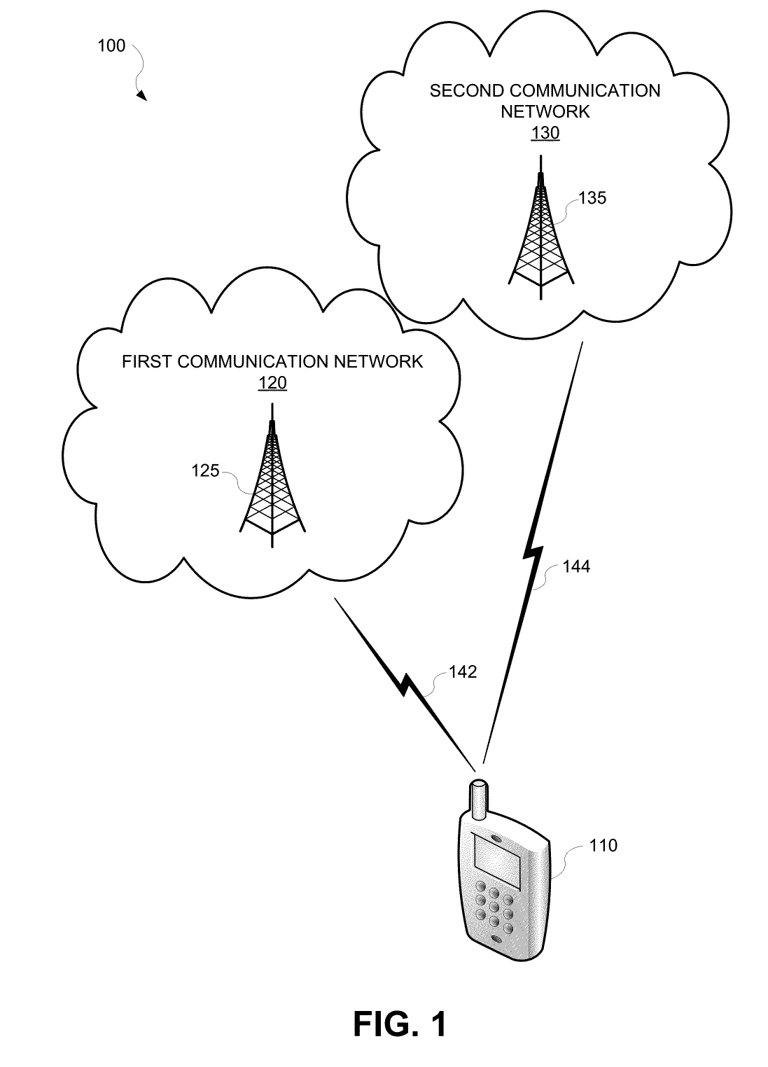

FIG. 1 is a system diagram illustrating a network environment 100 for various embodiments. Referring to FIG. 1, a mobile communication device 110 may communicate with a first communication network 120 using a first subscription 142. The mobile communication device 110 may also communicate with a second communication network 130 using a second subscription 144. In various embodiments, the first communication network 120 and the second communication network 130 may each be, for example, but not limited to, a wireless or mobile communication network.

The first communication network 120 may include a plurality of BTSs including, for example, but not limited to, a first BTS 125. The second communication network 130 may also include a plurality of BTSs, including, for example, but not limited to, a second BTS 135. A person of ordinary skill in the art can appreciate that the network environment 100 may include any number of communication networks, mobile communication devices, and BTSs without departing from the scope of the present inventive concept.

The mobile communication device 110 may communicate with the first communication network 120 on a first subscription 142 via the first BTS 125. For example, the mobile communication device 110 may acquire the first communication network 120 on the first subscription 142 and camp on the first BTS 125. The mobile communication device 110 may also communicate with the second communication network 130 on a second subscription 144 via the second BTS 135. For example, the mobile communication device 110 may acquire the second communication network 130 on the second subscription 144 and camp on the second BTS 135.

In various embodiments, the mobile communication device 110 may perform various activities on the first subscription 142 including, for example, but not limited to, the transmission of short data packets to the first BTS 125 on the random access channel (RACH). The mobile communication device 110 may also perform various activities on the second subscription 144 including, for example, but not limited to, the reception of paging messages broadcast by the second BTS 135 on the PCH. A person of ordinary skill in the art can appreciate that the same or different activities may be performed on the first subscription 142 and the second subscription 144. Moreover, the activities performed on the first subscription 142 may be independent of the activities performed on the second subscription 144.

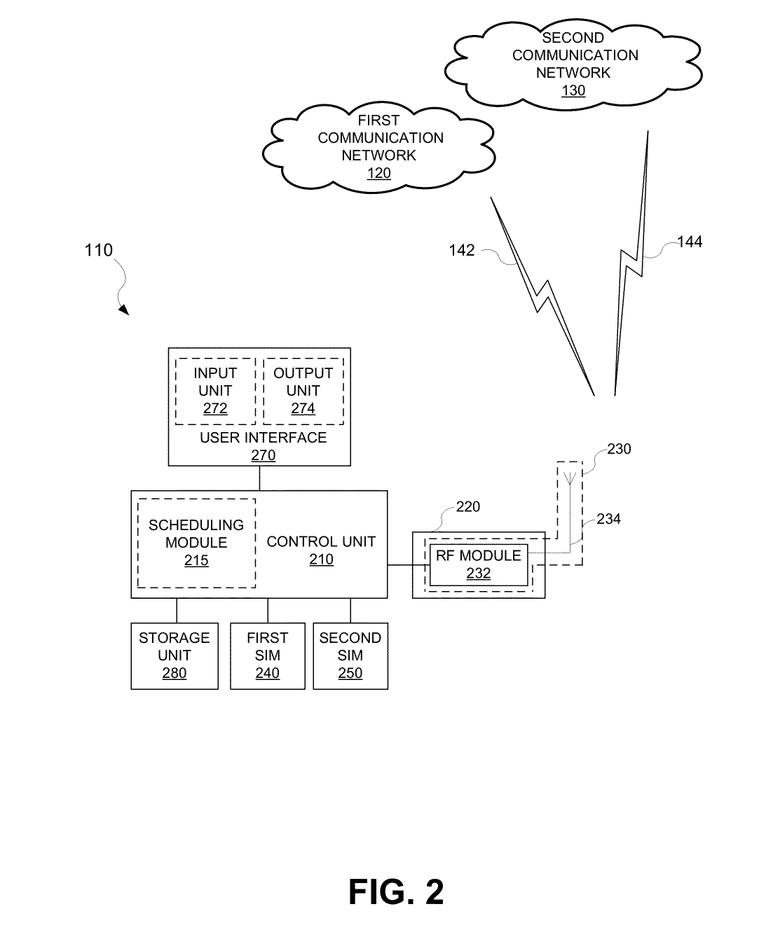

FIG. 2 is a block diagram illustrating the mobile communication device 110 (FIG. 1) according to various embodiments. Referring to FIGS. 1 and 2, in various embodiments, the mobile communication device 110 may include a control unit 210, a communication unit 220, a first SIM 240, a second SIM 250, a user interface 270, and a storage unit 280.

In various embodiments, the mobile communication device 110 may be any device capable of wirelessly communicating with one or more communication networks. In various embodiments, the mobile communication device 110 may be, for example, but not limited to, a smartphone, a tablet PC, or a laptop computer.

In various embodiments, the communication unit 220 may include an RF module 232. The RF module 232 may be part of an RF chain 230. In addition, the RF chain 230 may include, for example, but not limited to, an antenna 234. Although the mobile communication device 110 is shown to include a single communication unit (e.g., the communication unit 220), a person of ordinary skill in the art can appreciate that the mobile communication device 110 may include additional communication units without departing from the scope of the present inventive concept.

In various embodiments, the first SIM 240 may associate the communication unit 220 with the first subscription 142 on the first communication network 120 while the second SIM 250 may associate the communication unit 220 with the second subscription 144 on the second communication network 130.

In various embodiments, the first communication network 120 and the second communication network 130 may be operated by the same or different service providers. Additionally, in various embodiments, the first communication network 120 and the second communication network 130 may each support the same or different radio access technologies (RATs), including, for example, but not limited to Wideband Code Division Multiple Access (WCDMA), Global System for Mobile communications (GSM), Long Term Evolution (LTE), and Time Division-Synchronous Code Division Multiple Access (TD-SCDMA).

In various embodiments, the user interface 270 may include an input unit 272. In some embodiments, the input unit 272 may be, for example, but not limited to, a keyboard or a touch panel. In various embodiments, the user interface 270 may include an output unit 274. In some embodiments, the output unit 274 may be, for example, but not limited to, a liquid crystal display (LCD) or a light emitting diode (LED) display. A person of ordinary skill in the art will appreciate that other types or forms of input and output units may be used without departing from the scope of the present inventive concept.

In various embodiments, the control unit 210 may be configured to control the overall operation of the mobile communication device 110 including controlling the functions of the communication unit 220. In various embodiments, the control unit 210 may include a scheduling module 215. In various embodiments, the control unit 210 may be, for example, but not limited to, a microprocessor (e.g., general-purpose processor, baseband modem processor, etc.) or a microcontroller.

In various embodiments, the storage unit 280 may be configured to store application programs, application data, and user data. In various embodiments, at least some of the application programs stored at the storage unit 280 may be executed by the control unit 210 for the operation of the mobile communication device 110.

In various embodiments, the control unit 210 may be configured to determine when an activity on one subscription may conflict with an activity on another subscription. For example, the mobile communication device 110 may perform page receptions on the second subscription 144 according to a schedule (e.g., every 470 milliseconds (ms)). The control unit 210 may detect a short data packet transmission on the first subscription 142 that may conflict with a scheduled page reception on the second subscription 144.

Performing the short data packet transmission on the first subscription 142 may prevent the performance of the scheduled page reception on the second subscription 144. Thus, the control unit 210 may defer the short data packet transmission on the first subscription 142 in order to utilize the RF chain 230 and perform the scheduled page reception on the second subscription 144. The short data packet transmission on the first subscription 142 may be performed after the scheduled page reception is performed on the second subscription 144.

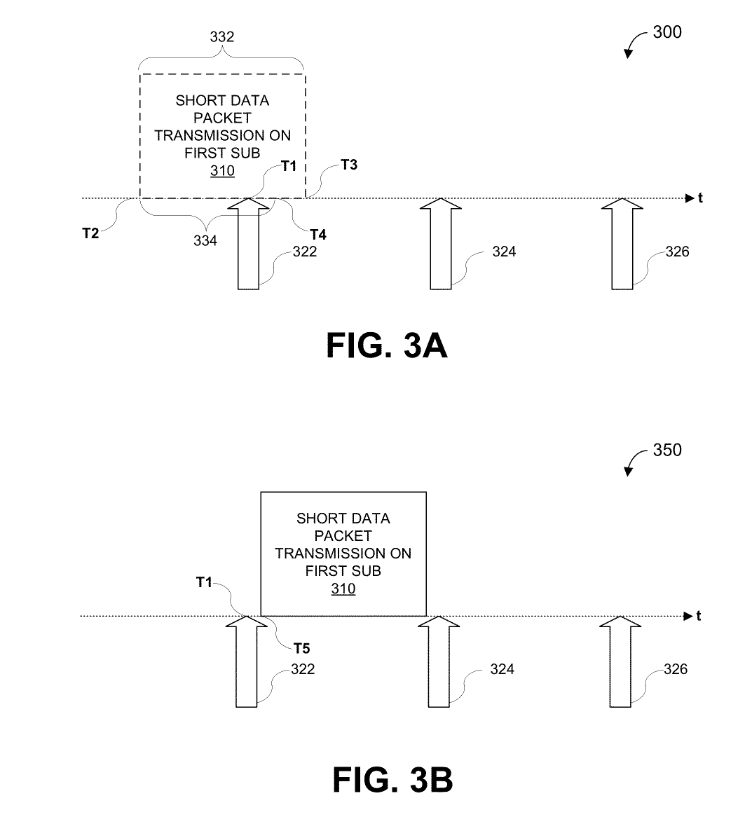

FIG. 3A is a timeline illustrating a sequence 300 of activities performed on multiple subscriptions according to various embodiments. Referring to FIGS. 1-3A, in various embodiments, the mobile communication device 110 may perform activities on the first subscription 142 and the second subscription 144.

In the sequence 300, the mobile communication device 110 may be about to perform a short data packet transmission 310 on the first subscription 142 over a first time period 332. However, the mobile communication device 110 may also be scheduled to perform a first page reception 322 on the second subscription 144 during the first time period 332 required to perform the short data packet transmission 310.

The mobile communication device 110 may perform page receptions on the second subscription 144 based on a schedule that corresponds to a length of a discontinuous reception (DRx) cycle associated with the second subscription 144. In addition to the first page reception 322, the mobile communication device 110 may perform, for example, but not limited to, a second page reception 324 and a third page reception 326 on the second subscription 144.

A same amount of time (e.g., 470 ms) may elapse between the first page reception 322 and the second page reception 324, and between the second page reception 324 and the third page reception 326. Based on the page reception schedule, the mobile communication device 110 may be scheduled to perform the first page reception 322 at a first time T1.

The performance of the short data packet transmission 310 on the first subscription 142 may conflict with the first page reception 322 that is scheduled to be performed on the second subscription 144. For example, the first page reception 322 may be scheduled to be performed during the first time period 332 required to perform the short data packet transmission 310.

To determine whether a conflict exists, the control unit 210 may look ahead over an amount of time and determine whether the first page reception 322 will be performed during at least a portion of the first time period 332 that may be required to perform the short data packet transmission 310 on the first subscription 142. Thus, the control unit 210 may look ahead over a second time period 334 to determine whether the first page reception 322 will be performed during the second time period 334 that includes at least a portion of the first time period 332.

For example, the short data packet transmission 310 may be performed over the first time period 332 starting at a second time T2 and ending at a third time T3. The first time period 332 may be, for example, 10 ms or another length of time. The control unit 210 may look ahead an amount of time (i.e., the second time period 334) to determine whether the first page reception 322 will be performed during at least a portion of the first time period 332. The second time period 334 may be, for example, 5 ms or another length of time. As such, the second time period 334 may start at the second time T2 but may end at a fourth time T4 before the end of the first time period 332 at the third time T3.

A person having ordinary skill in the art can appreciate that the control unit 210 may look ahead over a different length of time in order to determine whether the first page reception 322 will be performed during the first time period 332. Thus, the second time period 334 may have a shorter, longer, or same length than the first time period 332 without departing from the scope of the present inventive concept.

A length of the second time period 334 may be determined based on a condition of the radio channel on the second subscription 144 between the mobile communication device 110 and the second communication network 130. For example, the second time period 334 may overlap with at least a portion of the first time period 332. During the second time period 334, the control unit 210 may be able to utilize the RF chain 230 to perform a page reception (e.g., the first page reception 322) on the second subscription 144. Consequently, the control unit 210 may defer any short data packet transmission that may be performed on the first subscription 142 (e.g., the short data packet transmission 310) during at least a portion of the second time period 334.

Although the second time period 334 is shown to start at time T2 and end at time T4, a person having ordinary skill in the art can appreciate that the second time period 334 may start and end at different times without departing from the scope of the present disclosure. The length of the second time period 334 may also be different without departing from the scope of the present inventive concept. In addition, the second time period 334 may overlap with a different portion of the first time period 332 without departing from the scope of the present inventive concept.

FIG. 3B is a timeline illustrating a sequence 350 of activities performed on multiple subscriptions according to various embodiments. Referring to FIGS. 1-3B, in various embodiments, the mobile communication device 110 may defer the short data packet transmission on the first subscription 142.

In order to permit the first page reception 322 to be performed on the second subscription 144, the control unit 210 may be configured to defer the short data packet transmission 310 on the first subscription 142. In the sequence 350, the control unit 210 may not perform the short data packet transmission 310 on the first subscription 142 over the first time period 332 that starts at time T2. Instead, the control unit 210 may perform the first page reception 322 on the second subscription 144 at time T1. After performing the first page reception 322, the control unit 210 may perform the short data packet transmission 310 on the first subscription 142 at a fifth time T5.

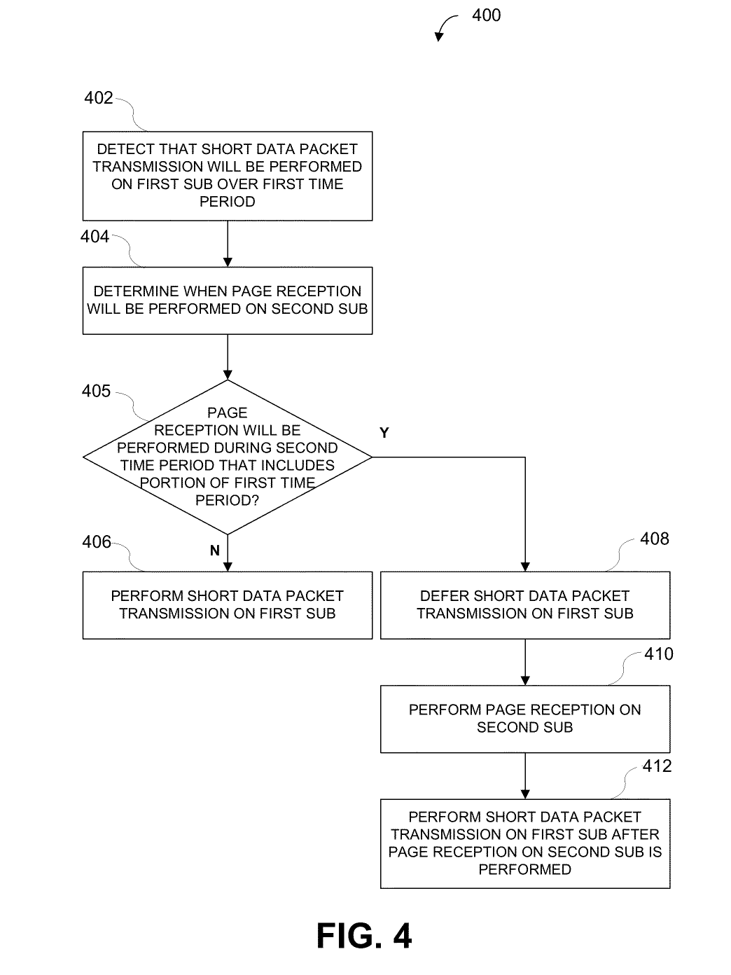

FIG. 4 is a flowchart illustrating a process 400 for scheduling activities performed on multiple subscriptions according to various embodiments. With references to FIGS. 1-4, in various embodiments, the process 400 may be performed by the control unit 210, for example, by the scheduling module 215.

The control unit 210 may detect that a short data packet transmission 310 will be performed on the first subscription 142 over a first time period 332 (402). For example, the control unit 210 may detect that the short data packet transmission 310 will be performed on the first subscription 142 over the first time period 332.

The control unit 210 may determine a time when a page reception will be performed on a second subscription 144 (404). For example, the control unit 210 may determine when a page reception will be performed on the second subscription 144 based on a schedule. Page receptions may be performed on the second subscription 144 according to a schedule (e.g., every 470 ms) that may correspond to the length of the DRx cycle associated with the second subscription 144. Based on the page reception schedule, the control unit 210 may determine that the first page reception 322 will be performed on the second subscription 144 at time T1.

The control unit 210 may determine whether the page reception will be performed on the second subscription 144 during a second time period 334 that includes at least a portion of the first time period 332 (405). For example, the control unit 210 may determine whether the first page reception 322 will be performed during the second time period 334. The second time period 334 may overlap with at least a portion of the first time period 332 over which the short data packet transmission 310 may be performed on the first subscription 142. For example, both the first time period 332 and the second time period 334 may start at time T2, but the second time period 334 may end before the first time period 332 at time T4. Alternately, the second time period 334 may start during the first time period 332 (i.e., after time T2 but before time T4).

The control unit 210 may determine that a page reception is not scheduled to be performed on the second subscription 144 during the second time period 334 (405-N). For example, the control unit 210 may determine that the first page reception 322 is not scheduled to be performed on the second subscription 144 during the second time period 334 if time T1 is not equal to or greater than time T2, and/or if time T1 is not equal to or less than time T4.

If the first page reception 322 is not scheduled to be performed during the second time period 334, then the control unit 210 may determine that no page reception will be performed during at least a portion of the first time period 332 over which the short data packet transmission 310 may be performed. As such, the control unit 210 may perform the short data packet transmission 310 on the first subscription 142 (406). For example, the control unit 210 may utilize the RF chain 230 to perform the short data packet transmission 310 on the first subscription 142 at time T2.

Alternately, the control unit 210 may determine that a page reception will be performed on the second subscription 144 during the second time period 334 (405-Y). For example, the control unit 210 may determine that the first page reception 322 will be performed during the second time period 334 if time T1 is equal to or greater than time T2, and time T1 is less than or equal to time T4.

The control unit 210 may determine that the first page reception 322 will be performed during the second time period 334, which includes at least a portion of the first time period 332 over which the short data packet transmission 310 may be performed. As such, the control unit 210 may determine that the performance of the short data packet transmission 310 on the first subscription 142 may conflict with the scheduled performance of the first page reception 322 on the second subscription 144.

If the control unit 210 determines that a page reception will be performed on the second subscription 144 during the second time period 334, the control unit 210 may defer the short data packet transmission 310 on the first subscription 142 (408). For example, the control unit 210 may not utilize the RF chain 230 to perform the short data packet transmission 310 on the first subscription 142 until after the first page reception 322 is performed on the second subscription 144.

Instead, the control unit 210 may perform the page reception on the second subscription 144 (410). For example, the control unit 210 may use the RF chain 230 and perform the first page reception 322 on the second subscription 144 at time T1.

The control unit 210 may perform the short data packet transmission 310 on the first subscription 142 after the page reception on the second subscription 144 is performed (412). For example, after the control unit 210 utilizes the RF chain 230 to perform the first page reception 322 on the second subscription 144, the control unit 210 may utilize the RF chain 230 to perform the short data packet transmission 310 on the first subscription 142 at time T5.

Although the process 400 is described with respect to the first subscription 142, a person having ordinary skill in the art can appreciate that the process 400 can also be performed with respect to the second subscription 144 without departing from the scope of the present inventive concept.

The accompanying claims and their equivalents are intended to cover such forms or modifications as would fall within the scope and spirit of the protection. For example, the example apparatuses, methods, and systems disclosed herein may be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present inventive concept.

The hardware used to implement the various illustrative logics, logical blocks, modules, and circuits described in connection with the various embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include random access memory (RAM), read-only memory (ROM), electrically erasable programmable read-only memory (EEPROM), FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

1. A method, comprising:
detecting that a short data packet transmission will be performed on a first subscription over a first time period;
determining whether a page reception will be performed on a second subscription during a second time period that includes at least a portion of the first time period; and
in response to a determination that the page reception is scheduled to be performed on the second subscription during the second time period, deferring a start of the short data packet transmission on the first subscription until after the page reception on the second subscription is performed.

2. The method of claim 1, wherein a length of the second time period is determined based at least in part on a condition of a radio channel on the second subscription.

3. The method of claim 1, further comprising determining, based at least in part on a page reception schedule, that the page reception will be performed on the second subscription at a first time.

4. The method of claim 3, wherein the page reception schedule corresponds to a length of a discontinuous reception (DRx) cycle associated with the second subscription.

5. The method of claim 3, wherein the first time period and the second time period start at a second time.

6. The method of claim 5, wherein the first time period ends at a third time and the second time period ends at a fourth time.

7. The method of claim 6, wherein determining whether a page reception will be performed on the second subscription during the second time period comprises:
determining whether the first time is equal to or greater than the second time; and
determining whether the first time is equal to or less than the fourth time.

8. The method of claim 1, further comprising:
performing the page reception on the second subscription; and
performing the short data packet transmission on the first subscription after the page reception on the second subscription is performed.

9. The method of claim 1, further comprising in response to determining that the page reception is not scheduled to be performed on the second subscription during the second time period, performing the short data packet transmission on the first subscription.

10. The method of claim 9, wherein the short data packet transmission on the first subscription is performed on a random access channel (RACH).

11. A mobile communication device, comprising:
a radio frequency (RF) chain; and
a control unit configured to:
detect that a short data packet transmission will be performed on a first subscription over a first time period;
determine whether a page reception will be performed on a second subscription during a second time period that includes at least a portion of the first time period; and
in response to determining that the page reception will be performed on the second subscription during the second time period, defer a start of the short data packet transmission on the first subscription until after the page reception on the second subscription is performed.

12. The mobile communication device of claim 11, wherein a length of the second time period is determined based at least in part on a condition of a radio channel on the second subscription.

13. The mobile communication device of claim 11, wherein the control unit is further configured to determine, based at least in part on a page reception schedule, that the page reception will be performed on the second subscription at a first time.

14. The mobile communication device of claim 13, wherein the page reception schedule corresponds to a length of a discontinuous reception (DRx) cycle associated with the second subscription.

15. The mobile communication device of claim 13, wherein the first time period and the second time period start at a second time.

16. The mobile communication device of claim 15, wherein the first time period ends at a third time and the second time period ends at a fourth time.

17. The mobile communication device of claim 16, wherein to determine whether a page reception will be performed on the second subscription during the second time period, the control unit is configured to:
determine whether the first time is equal to or greater than the second time; and
determine whether the first time is equal to or less than the fourth time.

18. The mobile communication device of claim 11, wherein the control unit is further configured to:
utilize the RF chain to perform the page reception on the second subscription; and
utilize the RF chain to perform the short data packet transmission on the first subscription after the page reception on the second subscription is performed.

19. The mobile communication device of claim 11, wherein the control unit is further configured to:
in response to determining that the page reception is not scheduled to be performed on the second subscription during the second time period, utilize the RF chain to perform the short data packet transmission on the first subscription.

20. The mobile communication device of claim 19, wherein the short data packet transmission on the first subscription is performed on a random access channel (RACH).

21. A non-transitory computer readable medium having stored thereon instructions for causing one or more processors to perform operations comprising:
detecting that a short data packet transmission will be performed on a first subscription over a first time period;
determining whether a page reception will be performed on a second subscription during a second time period that includes at least a portion of the first time period; and
in response to a determination that the page reception will be performed on the second subscription during the second time period, deferring a start of the short data packet transmission on the first subscription until after the page reception on the second subscription is performed.

22. A mobile communication device, comprising:
means for detecting that a short data packet transmission will be performed on a first subscription over a first time period;
means for determining whether a page reception will be performed on a second subscription during a second time period that includes at least a portion of the first time period; and
in response to a determination that the page reception is scheduled to be performed on the second subscription during the second time period, means for deferring a start of the short data packet transmission on the first subscription until after the page reception on the second subscription is performed.
